(19) United States
(12) Patent Application Publication
(10) Pub. No.: US 2020/0000021 A1
(43) Pub. Date: Jan. 2, 2020

(54) FOLDING TOOL BAR WITH NARROW FRONTAL PROFILE

(71) Applicant: FAST GLOBAL SOLUTIONS, INC., Glenwood, MN (US)

(72) Inventors: James Bruce PROHASKA, Prior Lake, MN (US); Kurt Mitchell FORTH, Cologne, MN (US)

(73) Assignee: Fast Global Solutions, Inc., Glenwood, MN (US)

(21) Appl. No.: 16/480,219

(22) PCT Filed: Nov. 2, 2017
(86) PCT No.: PCT/US2017/059705

§ 371 Date: Jul. 23, 2019

Related U.S. Application Data
(60) Provisional application No. 62/455,805, filed on Feb. 7, 2017.

(51) Int. Cl. A01C 23/02; A01B 73/06; A01C 23/00

(52) U.S. Cl. CPC A01C 23/023; A01C 23/008; A01B 73/06

(57) ABSTRACT

An agricultural implement with a folding tool bar arrangement for an improved, narrow frontal profile when in a transport configuration. The tool bar is folded in multi-planar manner to achieve frontal profiles that are substantially reduced relative to conventional folding tool bars. The reduced frontal profile enables operators to provide right-of-way to passing vehicles on standard roadways without need for encroaching the shoulder or ditch of the roadway.

### RELATED APPLICATIONS

This application claims the benefit of U.S. Provisional Patent Application No. 62/455,805, filed Feb. 7, 2017, the disclosure of which is hereby incorporated by reference herein in its entirety.

### FIELD OF THE DISCLOSURE

The disclosure is directed to agricultural implements generally, and more specifically to fertilizer applicators with folding tool bars.

### BACKGROUND OF THE DISCLOSURE

Farm equipment operators are required to yield the right-of-way while towing implements on public roads and highways. Specifically, the operator must maneuver the towing vehicle and towed implement such that the entire implement does not cross the centerline of the road or highway.

Many agricultural implements are wider in overall width than the standard highway 11 foot lane width when folded in their transport configuration. The wider the overall width of the implement, beyond the 11 foot lane width, the more difficult it is for the operator to maneuver the implement to yield the right-of-way because the implement tires on the side of the implement opposite the centerline of the road may need to operate partially in the adjacent road ditch. This can induce instability of the implement as well potential interference between the bottom of the implement and the road or shoulder of the road due to the implement tires operating down partially in the ditch.

An improved apparatus and method that avoids the necessity of transporting the agricultural implement partially on the shoulder or in the adjacent road ditch would be welcomed.

### SUMMARY OF THE DISCLOSURE

In various embodiments of the disclosure, a towed agricultural implement is disclosed having a folding tool bar that stows substantially within the width of the wheel base of the towed implement. For some embodiments, the overall transport width of the implement is no wider than 12 feet. By scaling of the wing lengths and geometric relationships of this embodiment, the overall transport width of the implement can be designed to be less than 12 feet. For these embodiments, the equipment operator only has to maneuver the implement such that the implement centerline operates only 1 foot toward the adjacent road edge to be clear of the opposite lane and attendant oncoming traffic. With the implement tires set at a track width of 10 feet, as an example, the implement tire opposite the centerline of the road will operate on the edge of the paved road or on the shoulder and not partially down in the ditch. This allows for safer operation, and the operator can maintain a steady travel speed which is safer for traffic approaching from the rear of the implement.

Agricultural implements are typically towed from the front of the implement by a tractor. The tractor operator must look through the rear window of the tractor cab or use the side rear view mirrors on the outside of the tractor cab to see vehicles approaching from the rear. Often, when in a folded transport configuration, the implement blocks the operator's view to rear-approaching vehicles or objects either through the rear cab window or from the side rear view mirrors or both. For various embodiments of the disclosure, the folded transport configuration of the toolbar specifically allows for a view of rear—approaching vehicles from the tractor operator's position through the rear window of the cab, while still providing the narrower overall width. For various embodiments, the liquid tank includes a rearward, progressively-downward sloping top surface which allows the tractor operator to maintain visibility of rear-approaching vehicles and objects as those vehicles or objects get closer to the rear of the towed implement.

Conventional folding techniques are limited to a combination of vertical planar and horizontal planar motions for the folding the wings. To reduce the overall width limitation in the transport configuration, a combination of vertical planar and multi-planar, coordinated motion disclosed. This two-dimensional folding scheme reduces the overall transport width of the implement while permitting the carriage and holding tank to accommodate sufficient capacity requirements.

In some embodiments, the implement includes mid-wing sections and flip wing sections that are positioned closer to the center plane of the carriage of the implement when in the stowed or transport configuration. The distal ends of inner wing sections follow an arc, with the arc center at the pivot axes at the proximal ends of the inner wing sections, so that the motion of the inner wing sections is both upward and inward with respect to the vertical center plane of the carriage. Also, in various embodiments, the folding of the inner wing sections and the mid-wing section is at least partially simultaneous, thereby reducing the time required to fold and unfold the implement.

In various embodiments, the ratio of a tool bar assembly width for a fertilizer applicator in a field or extended configuration to the tool bar assembly width in a transport configuration is significant. In one embodiment, a width of a tool bar assembly for a liquid fertilizer applicator in a field configuration is 60 feet wide, while, the width in a transport configuration is 12 feet, thus providing a 5:1 reduction ratio. Conventional folding techniques for fertilizer applicators of similar construction have lesser reduction ratios, in the range of 4.50:1 to 3.75:1. The lower the folding ratio, the less need for precise, integrated folding schemes.

Structurally, various embodiments of an agricultural implement assembly, such as a liquid fertilizer applicator, are disclosed, comprising a carriage defining a towing axis and a holding tank mounted to the carriage, the holding tank having a maximum horizontal width in a direction that is perpendicular to the towing axis. A central frame is coupled to a first end portion of the carriage and centered about the towing axis. A foldable tool bar includes a first wing section having a proximal end portion coupled to the central frame with a first hinge assembly, the first hinge assembly defining a first horizontal pivot axis that is substantially parallel to the towing axis. In some embodiments, the first horizontal pivot axis is within the maximum horizontal width of the holding tank. In some embodiments, the first wing section extends at an obtuse angle relative to a horizontal datum of the central frame when the liquid fertilizer applicator is in a transport configuration.

In some embodiments, the foldable tool bar includes a second wing section having a proximal end portion coupled to a distal end portion of the first wing section with a second hinge assembly, the second hinge assembly defining a second pivot axis that extends in a direction perpendicular to the first horizontal pivot axis. The second wing section may extend above a portion of the holding tank when the liquid fertilizer applicator is in the transport configuration. Also, in some embodiments, the second wing section extends substantially parallel to the towing axis when the liquid fertilizer applicator is in the transport configuration.

In some embodiments, the foldable tool bar includes a third wing section having a proximal end portion coupled to a distal end portion of the second wing section with a third hinge assembly, the third hinge assembly defining a third pivot axis that extends in a direction perpendicular to the second pivot axis. The third wing section may be folded substantially adjacent the second wing section when the liquid fertilizer applicator is in the transport configuration, the third wing section extending above a portion of the holding when the liquid fertilizer applicator is in the transport configuration. In some embodiments, a bracket is coupled to a second end portion of the carriage, the second wing section resting on the bracket when the liquid fertilizer applicator is in the transport configuration. In some embodiments, the first end portion of the carriage is a forward end portion of the carriage. In some embodiments, the central frame is a central tool bar section. In some embodiments, an inner wing latch assembly is configured to selectively secure the first wing section at an obtuse ramping angle relative to the central frame when in the transport configuration.

In various embodiments of the disclosure, the liquid fertilizer applicator includes an inner wing lift hydraulic cylinder that bridges the first horizontal pivot axis, a first end of the inner wing lift hydraulic cylinder being coupled to the central frame and a second end of the inner wing lift hydraulic cylinder being coupled to the first wing section. A mid-wing pivot hydraulic cylinder may also be included that bridges the second pivot axis, a first end of the mid-wing pivot hydraulic cylinder being coupled to the first wing section and a second end of the mid-wing pivot hydraulic cylinder being coupled to the second wing section. In some embodiments, an outer wing hydraulic cylinder bridges the third pivot axis, a first end of the outer wing hydraulic cylinder being coupled to the second wing section and a second end of the outer wing hydraulic cylinder being coupled to the third wing section. In some embodiments, the inner wing lift hydraulic cylinder is extended to configure the first wing section at an obtuse ramping angle relative to the central frame, and the inner wing lift hydraulic cylinder is retracted to configure the first wing section in a substantially horizontal orientation. The inner wing lift hydraulic cylinder may extend at an acute angle that is less than 45 degrees from horizontal when the liquid fertilizer applicator is in an extended configuration. In some embodiments, the inner wing lift hydraulic cylinder extends substantially, vertical when the liquid fertilizer applicator is in a transport configuration.

In some embodiments, the inner wing lift hydraulic cylinder, the central frame, and the first wing section are configured to counter a pitching moment about the first hinge assembly when the liquid fertilizer applicator is in the transport configuration. The inner wing lift hydraulic cylinder may be disposed rearward of the first wing section.

In various embodiments of the disclosure, a hydraulic system is configured to simultaneously actuate the inner wing lift hydraulic cylinder and the mid-wing pivot hydraulic cylinder for retraction of the foldable tool bar from a field configuration to a transport configuration, the hydraulic system being configured so that the inner wing lift hydraulic cylinder rotates the first wing section to a fixed lift angle before the mid-wing pivot hydraulic cylinder fully rotates the second wing section into the transport configuration. The inner wing lift hydraulic cylinder may be configured to extend during the simultaneous actuation, and the mid-wing pivot hydraulic cylinder may be configured to retract during the simultaneous actuation. In some embodiments, the hydraulic system is configured for actuation of the outer wing hydraulic cylinder to fold the third wing section into the transport configuration. The hydraulic system may be configured to fold the third wing section into the transport configuration before actuating the inner wing lift hydraulic cylinder and the mid-wing pivot hydraulic cylinder.

In some embodiments, a hydraulic system is configured to simultaneously actuate the inner wing lift hydraulic cylinder and the mid-wing pivot hydraulic cylinder for retraction of the foldable tool bar from a transport configuration to a field configuration, the hydraulic system being configured so that the mid-wing pivot hydraulic cylinder partially rotates the second wing section toward the field configuration before the inner wing lift hydraulic cylinder rotates the first wing section toward the field configuration. The inner wing lift hydraulic cylinder may be configured to retract during the simultaneous actuation, and the mid-wing pivot hydraulic cylinder may be configured to extend during the simultaneous actuation. In some embodiments, the hydraulic system is configured for actuation of the outer wing hydraulic cylinder to unfold the third wing section into the field configuration. The hydraulic system may be configured to unfold the third wing section into the field configuration after actuating the inner wing lift hydraulic cylinder and the mid-wing pivot hydraulic cylinder into the field configuration.

Various embodiments of the disclosure include a method of controlling the foldable tool bar of the liquid fertilizer applicator to retract from a field configuration to a transport configuration. The method comprises configuring a hydraulic system for simultaneous act of the inner wing lift hydraulic cylinder and the mid-wing pivot hydraulic cylinder, and adjusting at least one of a first hydraulic flow to the inner wing lift hydraulic cylinder and a second hydraulic flow to the mid-wing pivot hydraulic cylinder so that the inner wing lift hydraulic cylinder rotates the first wing section to a fixed lift angle before the mid-wing pivot hydraulic cylinder fully rotates the second wing section into the transport configuration. The inner wing lift hydraulic cylinder may be, extended during the simultaneous actuation, and the mid-wing pivot hydraulic cylinder may be retracted during the simultaneous actuation. In some embodiments, the method includes configuring the hydraulic system for actuation of the outer wing hydraulic cylinder to fold the third wing section into the transport configuration. In some embodiments, the method includes configuring the hydraulic system for actuation of the outer wing hydraulic cylinder to complete the folding of the third wing section into the transport configuration before the simultaneous actuation of the inner wing lift hydraulic cylinder and the mid-wing pivot hydraulic cylinder.

In some embodiments, a method of controlling the foldable tool bar of the liquid fertilizer applicator to extend from a transport configuration to a field configuration includes configuring a hydraulic system to initiate actuation of the mid-wing pivot hydraulic cylinder prior to initiating actuation of the inner wing lift hydraulic cylinder, and configuring the hydraulic system for simultaneous actuation of the mid-wing pivot hydraulic cylinder and the inner wing lift hydraulic cylinder after initiating actuation of the inner wing lift hydraulic cylinder. The inner wing lift hydraulic cylinder is retracted during actuation, and the mid-wing pivot hydraulic cylinder may be extended during actuation. In some embodiments, the method includes configuring the hydraulic system for actuation of the outer wing hydraulic cylinder to unfold the third wing section into the field configuration. In some embodiments, the method includes configuring the hydraulic system for actuation of the outer wing hydraulic cylinder to complete the unfolding of the third wing section into the field configuration after the simultaneous actuation of the mid-wing pivot hydraulic cylinder and the inner wing lift hydraulic cylinder.

### BRIEF DESCRIPTION OF THE DRAWINGS

FIG. 1 is a front perspective view of an agricultural implement with a tool bar in an extended configuration and a raised position according to an embodiment of the disclosure;

FIG. 2 is a front perspective view of the agricultural implement of FIG. 1 with the tool bar in an extended configuration and a ground engagement position according to an embodiment of the disclosure;

FIG. 3 is a top plan view of the agricultural implement of FIG. 1 according to an embodiment of the disclosure;

FIG. 4 is a partial, front perspective view depicting the left wing of the agricultural implement of FIG. 1 according to an embodiment of the disclosure;

FIG. 5 is an enlarged, front perspective view of a portion of the left wing of FIG. 4 according to an embodiment of the disclosure;

FIG. 6 is a rear perspective view of the left wing of the agricultural implement of FIG. 1 according to an embodiment of the disclosure;

FIG. 7 is a front, perspective view of the agricultural implement of FIG. 1 in a transport configuration according to an embodiment of the disclosure;

FIG. 8 is a front elevational view of the agricultural implement of FIG. 7 according to an embodiment of the disclosure;

FIG. 9 is a top plan view of the agricultural implement of FIG. 7 according to an embodiment of the disclosure;

FIG. 10 is a left side elevational view of the agricultural implement of FIG. 7 according to an embodiment of the disclosure;

FIG. 11 is a rear elevational view of the agricultural implement of FIG. 7 according to an embodiment of the disclosure;

FIG. 12 is a front elevational view of the agricultural implement of FIG. 7 sans the hitch for illustrative purposes, according to an embodiment of the disclosure;

FIG. 13 is a front perspective view of the agricultural implement of FIG. 12 according to an embodiment of the disclosure;

FIG. 14 is a partial, rear perspective view of a center section and an inner wing section of the tool bar of the agricultural implement of FIG. 1 according to an embodiment of the disclosure;

FIG. 15 is a partial, rear perspective view of the agricultural implement of FIG. 1 sans the hitch and holding tank for illustrative clarity, according to an embodiment of the disclosure;

FIG. 16 is a partial, rear perspective view of the agricultural implement of FIG. 7 sans the hitch and holding tank for illustrative clarity, according to an embodiment of the disclosure;

FIG. 17 is a schematic of a hydraulic system for controlling the foldable wings of the agricultural implement of FIG. 1 according to an embodiment of the disclosure;

FIG. 18 is a front perspective view of the holding tank of FIG. 1 in isolation according to an embodiment of the disclosure;

FIG. 19 is a front elevational view of the holding tank of FIG. 18;

FIG. 20 is a left side elevational view of the holding tank of FIG. 18;

FIG. 21 is a partial perspective view of the agricultural implement in the transport configuration of FIG. 7 as seen from the perspective of an operator towing the agricultural implement, according to an embodiment of the disclosure;

FIG. 22 is a side elevational view of the sight lines provided by the configuration of FIG. 20 according to an embodiment of the disclosure;

FIG. 23 is a front perspective view of an inner wing latch assembly in a retracted configuration and mounted to a tow bar according to an embodiment of the disclosure;

FIG. 24 is a front elevational view of the inner wing latch assembly of FIG. 23; and

FIG. 25 is a front elevational view of the agricultural implement of FIG. 7 including the inner wing latch assembly of FIG. 24 in a deployed configuration according to an embodiment of the disclosure.

### DETAILED DESCRIPTION OF THE FIGURES

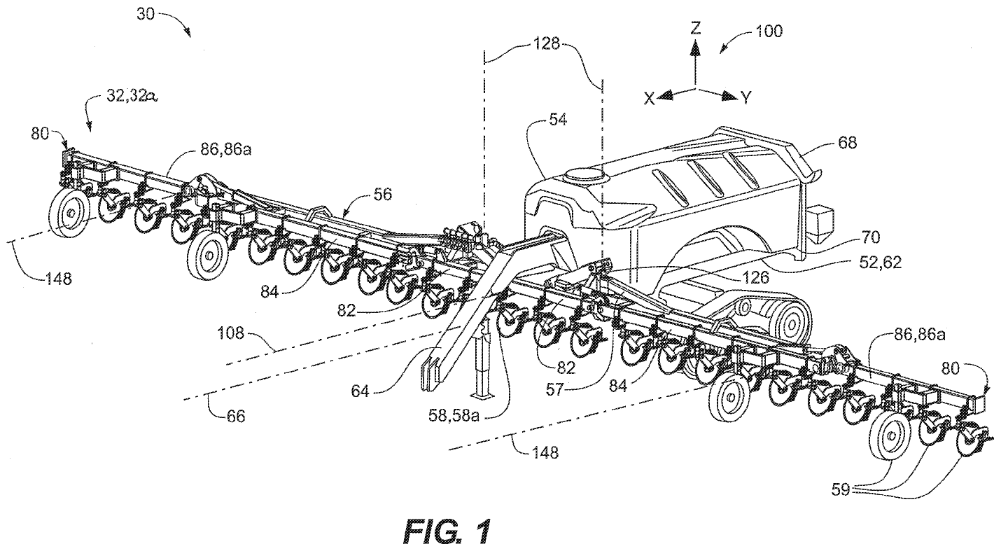

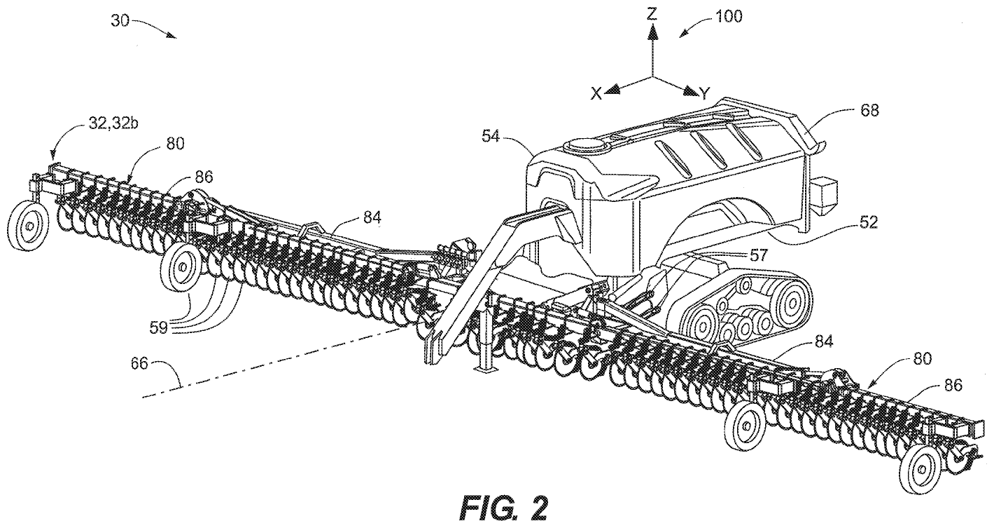

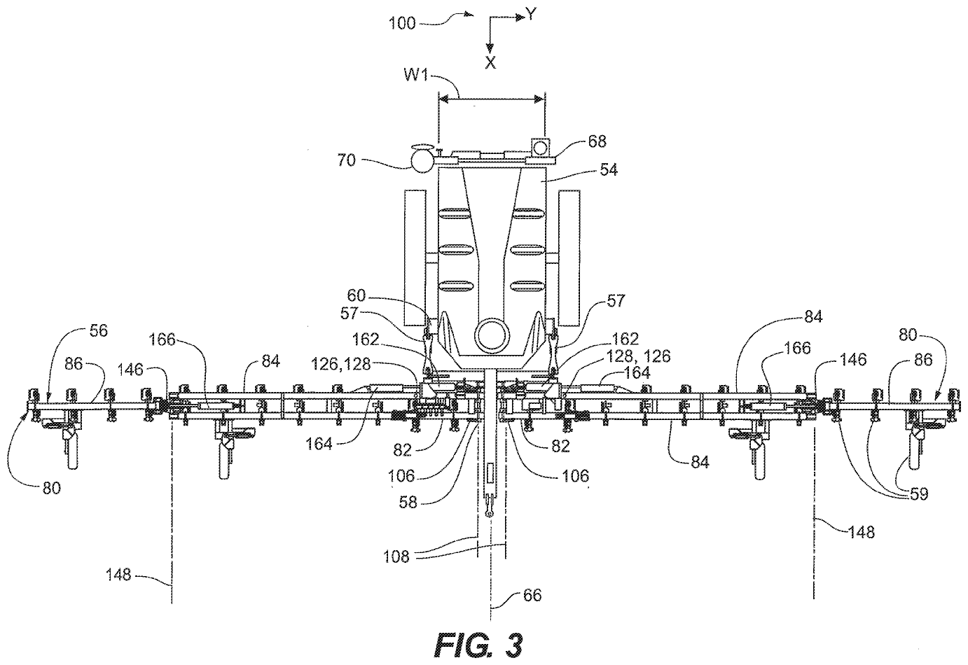

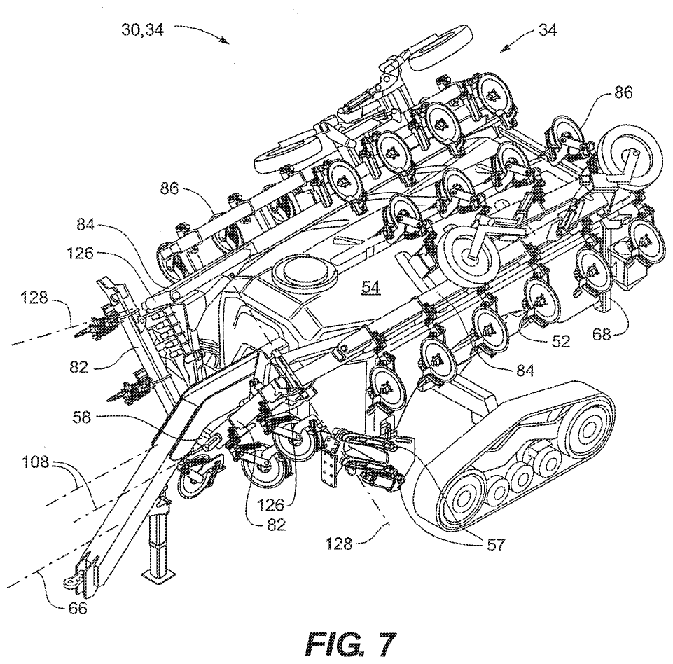

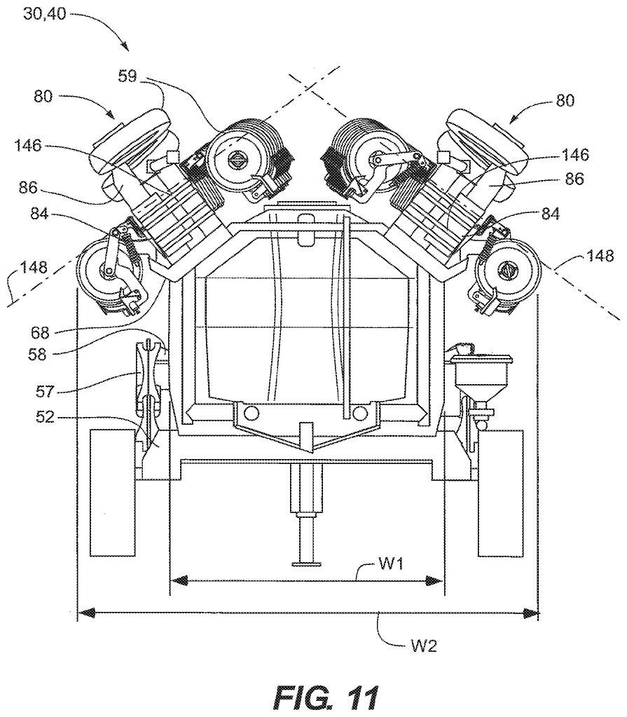

Referring to FIGS. 1 through 13, an agricultural implement assembly 30 is depicted in an extended or field configuration 32 and a transport configuration 34 in embodiments of the disclosure. The field configuration 32 is depicted in FIGS. 1 through 6, and the transport configuration 34 in FIGS. 7 through 13. The field configuration includes two positions: a raised position 32a (FIG. 1) and a ground engagement position 32b (FIG. 2). Also, the agricultural implement assembly 30 as depicted in FIG. 2 is outfitted for application of liquid fertilizer in a 15-inch row configuration, while the depictions of the other figures in the application depict the agricultural implement assembly 30 as outfitted for application liquid fertilizer in a 30-inch row configuration.

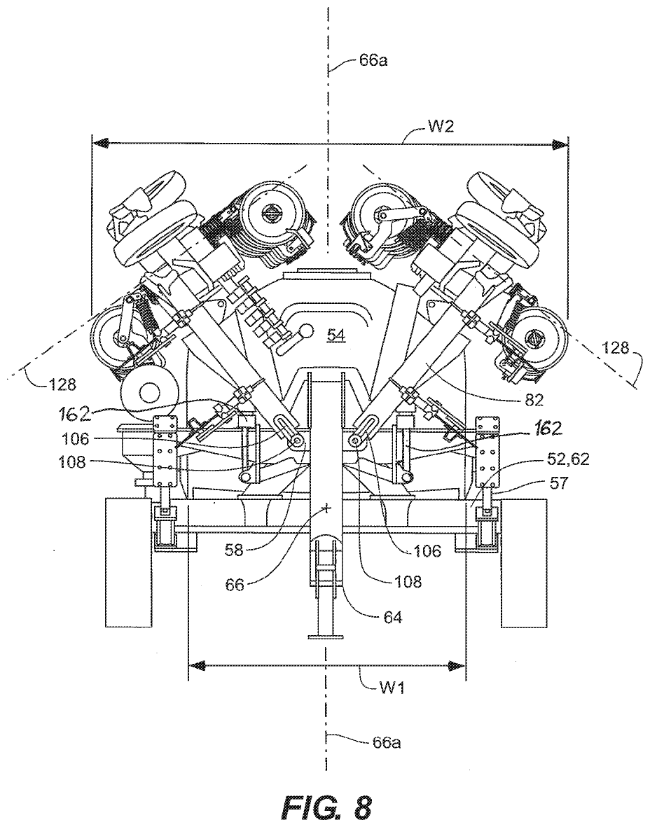

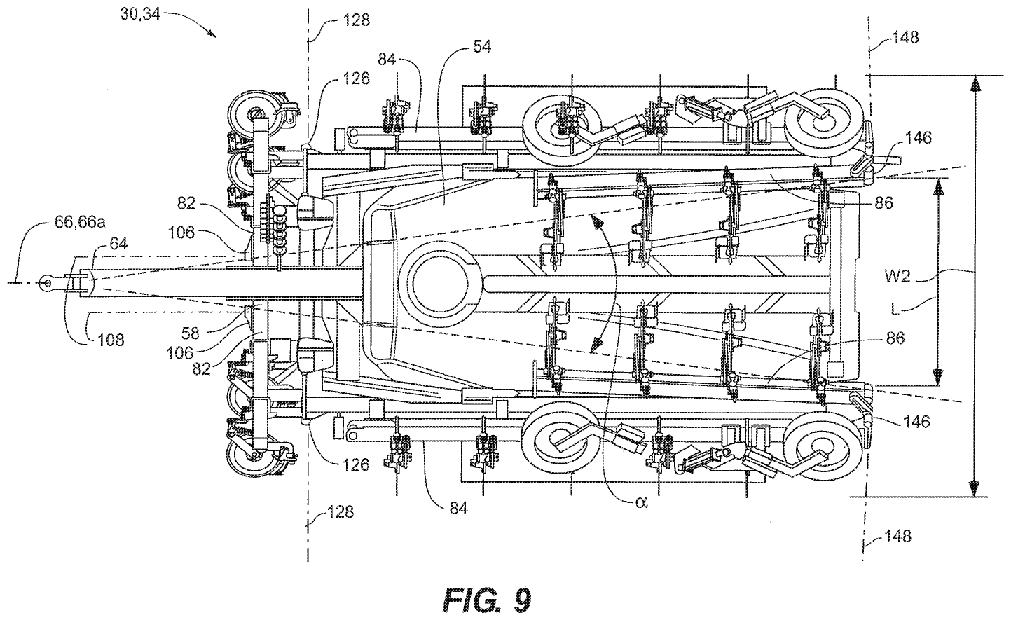

The agricultural implement assembly 30 includes a carriage 52, a holding tank 54 mounted to the carriage 52, and a tool bar assembly 56 coupled to the carriage 52 via parallel linkages 57. A plurality of ground engagement tools 59, such as coulters and gauge wheels, are coupled to the tool bar assembly 56. In the depicted embodiment, the tool bar assembly 56 includes a central frame 58 mounted to a front end 60 of the carriage 52, the central frame 58 being centered about a towing axis 66 and coupled to two foldable wing assemblies 80. The carriage 52 may include a carriage frame 62 and a tow bar 64, such as the goose neck tow bar depicted. In the depicted embodiment, the towing axis 66 represents an axis along which the agricultural implement assembly 30 is towed in operation and about which the agricultural implement assembly 30 is substantially centered. It is noted that the vertical location of the towing axis 66 is arbitrary, and may be located anywhere on a vertical plane 66a that passes through the center of the carriage 52 (FIGS. 8 and 9). In some embodiments, a bracket 68 is mounted to a rear end portion 70 of the carriage 52, the bracket 68 extending above a portion of the holding tank 54.

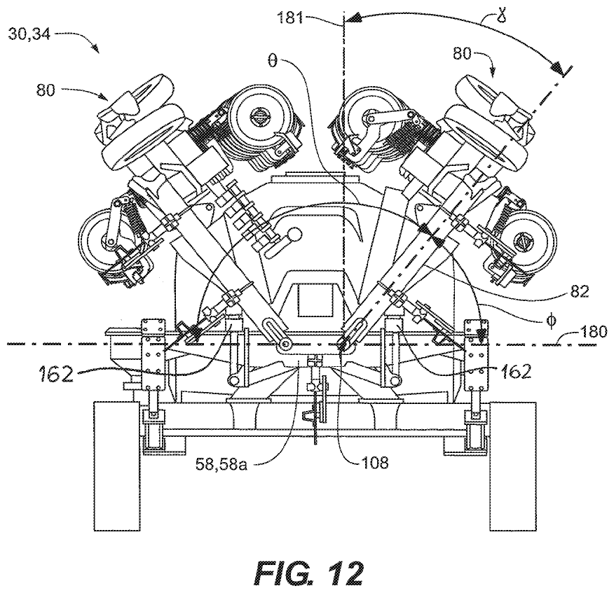

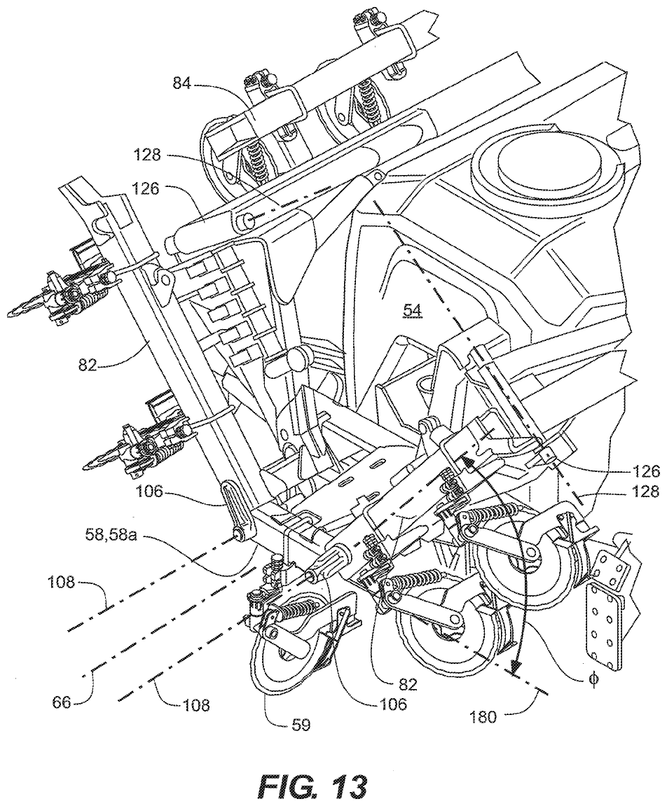

Each foldable wing assembly 80 includes an inner wing section 82 and a mid-wing section 84, and may include an outer wing section 86. In the depicted embodiment, the outer wing sections 86 are flip wing sections 86a, capable of being folded or “flipped” into an orientation that extends adjacent to and generally above the connected mid-wing section 84. Also in the depicted embodiment, the central frame 58 is also a toolbar 58a (FIGS. 12 and 13), meaning that ground engagement tools can be mounted thereon for operation. In various embodiments, the central frame 58 and the various sections 82, 84, and 86 include a weldment frame work.

The holding tank 54 defines a maximum horizontal tank width W1 (FIG. 8) that is centered about the towing axis 66 and extends in a horizontal lateral direction that is perpendicular to the towing axis 66 (i.e., the “y” direction of Cartesian coordinate 100). The agricultural implement assembly 30 also defines an overall transport width W2 that also extends in the horizontal lateral direction perpendicular to the towing axis 66.

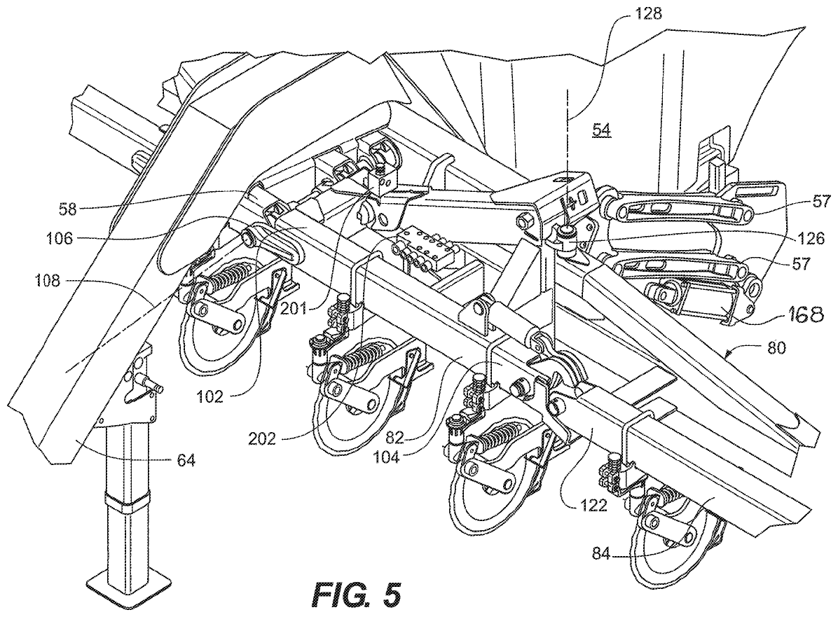

The inner wing section 82 (FIG. 5) includes a proximal end portion 102 and a distal end portion 104. The proximal end portion 102 is coupled to the central frame 58 with an inner hinge assembly 106 that defines a first horizontal pivot axis 108. The first horizontal pivot axis 108 may be substantially parallel to the towing axis 66. In the depicted embodiment, the first horizontal pivot axis 108 is defined within the maximum horizontal tank width W1 of the holding tank 54.

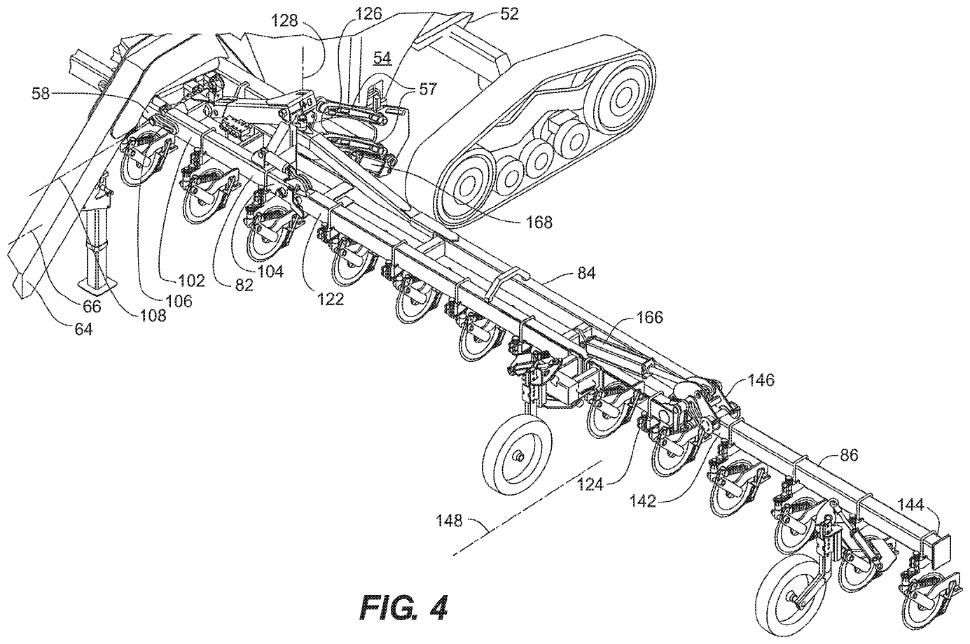

The mid-wing section 84 (FIGS. 4 through 6) includes a proximal end portion 122 and a distal end portion 124, the proximal end portion 122 being coupled to the distal end portion 104 of the inner wing section 82 with a second hinge assembly 126. In the depicted embodiment, the second hinge assembly 126 defines a second pivot axis 128 that extends in a direction that is substantially perpendicular to the first horizontal pivot axis 108. When in the field configuration 32, the pivot axis 128 extends in a generally vertical direction. When in the transport configuration 34, the second pivot axis 128 is canted from the vertical, but still extends in a direction or plane that is substantially perpendicular to the first horizontal pivot xis 108.

For embodiments where the outer wing section 86 is a flip wing 86a, the outer wing section 86 may be folded substantially adjacent the mid-wing section 84 when the agricultural implement assembly 30 is in the transport configuration 34. In some embodiments, the outer wing section 86 extends above at least a portion of the holding tank 54 when the agricultural implement assembly 30 is in the transport configuration

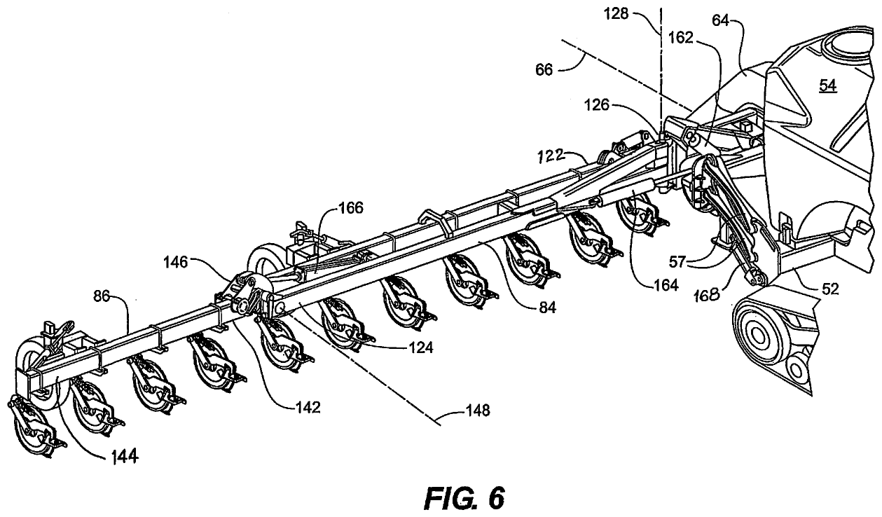

The outer wing section 86 (FIGS. 4 and 6) includes a proximal end portion 142 and a distal end portion 144. The proximal end portion 142 is coupled to the distal end portion 124 of the mid-wing section 86 with a third hinge assembly 146, the third hinge assembly 146 defining a third pivot axis 148 that extends in a direction perpendicular to the second pivot axis 128. When in the field configuration 32, the third pivot axis 148 extends in a generally horizontal direction and may extend substantially parallel to the first pivot axis 108. When in the transport configuration 34, the pivot axis 148 is not horizontal, but still extends in a direction that is substantially perpendicular to the second horizontal pivot axis 128.

In the depicted embodiment, the motivation of each wing section 82, 84, and 86 about the respective pivot axes 108, 128, and 148 is provided by hydraulic cylinders: an inner wing lift cylinder 162, a mid-wing pivot cylinder 164, and an outer wing cylinder 166. The hydraulic cylinders 162, 164, and 166 are coupled across or bridge the respective hinge assemblies 106, 126, and 146. Also in the depicted embodiment, at least one hydraulic cylinder 168 is coupled between the carriage 52 and the parallel linkages 57 for motivating the tool bar assembly between the raised position 32a and the ground engagement position 32b.

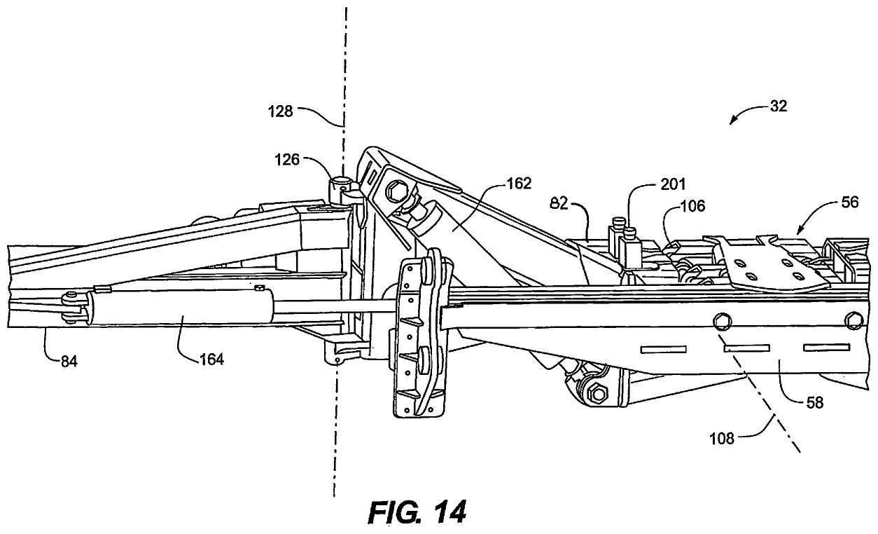

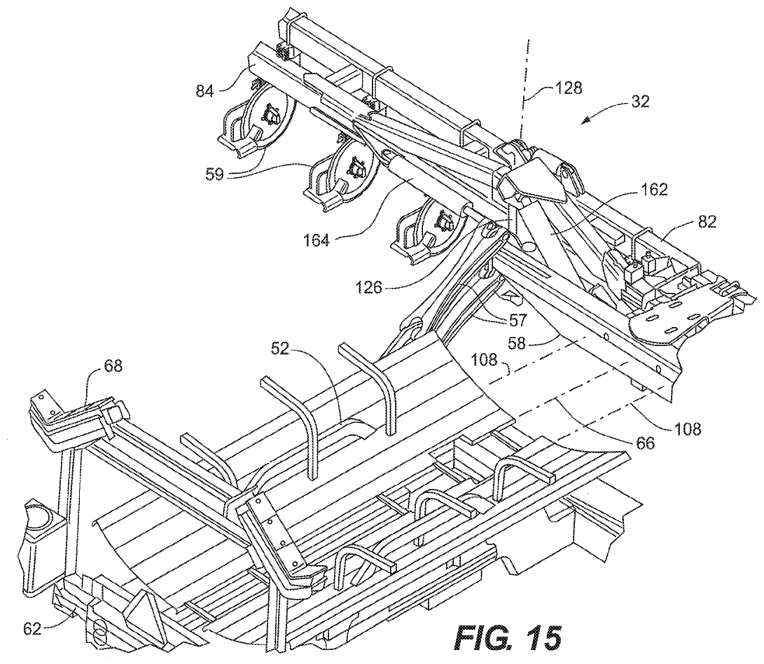

In the field configuration 32, the inner wing lift cylinder 162 is in a retracted configuration so that the inner wing section 82 is substantially horizontal. When retracted, the inner wing lift cylinder may be oriented at an acute angle relative to horizontal, as depicted in FIGS. 14 and 15. Also in the field configuration 32, the mid-wing pivot cylinder 164 and outer wing cylinder 166 (FIG. 4) are in an extended configuration, placing the mid-wing section 84 and the outer wing section 86 in lateral alignment with the inner wing section 82.

Referring to FIGS. 14 through 16 and again to FIGS. 4, 9, and 10, the folding operation of the foldable wing assembly 80 is described in an embodiment of the disclosure. In the transport configuration 34, the configurations of the cylinders 162, 164, and 166 are reversed from the field configuration 32; that is, the inner wing lift cylinder 162 is extended and the mid-wing pivot cylinder 164 and outer wing cylinder 166 are retracted (FIGS. 9, 10, and 16). Extension of the inner wing lift cylinder 162 causes the inner wing section 82 to rotate upward through a fixed lift angle θ, to assume a canted orientation that defines a ramping angle θ relative to a horizontal datum 180 of the central frame 58 (FIG. 12). In the depicted embodiment, the sum of the angles θ and 0 is substantially 180 degrees. The extension of the inner wing lift cylinder 162 may also be characterized as defining an angle γ relative to a vertical datum 181 (FIG. 12), where the angles and γ are complementary. Both datum 180 and 181 pass through the pivot axis 108 of a respective hinge assembly 106, with the datum 180 and 181 being orthogonal to each other and both being orthogonal to the pivot axis 108. In the depicted embodiment, the ramping angle θ is obtuse and the angle γ is acute.

In the depicted embodiment, the upward rotation of the inner wing section 82 caused by extension of the inner wing lift cylinder 162 also causes the inner wing lift cylinder 162 to rotate into an upright or near upright orientation, as depicted in FIGS. 8, 12, and 16. The upright or near upright orientation of the inner wing lift cylinder 162 provides support to the foldable wing assembly 80 when in the folded, transport configuration 34. The retraction of the mid-wing pivot cylinder 164 causes the mid-wing section 84 to rotate rearward about the second pivot axis 128. In the depicted embodiment, retraction of the outer wing cylinder 166 causes the outer wing section 86 to fold into a position adjacent the mid-wing section 84.

In some embodiments, the folding actions of the inner wing section 82 and the mid-wing section 84 occur simultaneously or semi-simultaneously. That is, at least part of the rearward pivoting sequence of the mid-wing section 84 occurs during the lifting rotation sequence of the inner wing section 82. Likewise, when unfolding the foldable wing assembly 80 from the transport configuration 34 to the field configuration 32, at least part of the lateral extension sequence of the mid-wing sections 84 may occur during the lowering rotation sequence of the inner wing section 82. In some embodiments, the outer wing section 86 is folded adjacent to the mid-wing section 84 prior to the pivoting sequence of the mid-wing section 84; however, simultaneous or semi-simultaneous sequencing of the folding of the outer wing section 86 and the mid-wing section 84 is also contemplated.

In one embodiment, the sequence for folding the wing assemblies 80 from the extended configuration to the transport configuration is as follows: The outer wing sections 86 are folded first in a vertical plane to a stopping point above the mid-wing sections 84. The outer wing sections 86 of both foldable wing assemblies 80 may be folded simultaneously. The mid-wing sections 84 and inner wing sections 82 may be folded simultaneously or semi-simultaneously in a coordinated, multi-planar motion. During the coordinated, multi-planar fold motion, the mid-wing sections 84 rotate rearwardly through approximately 90 degrees of rotation while the inner wing sections 82 rotate upward in a vertical plane through the lift angle θ relative to the horizontal datum 180. The sum of the lift angle t and the obtuse ramping angle θ is 180 degrees. The sum of the lift angle θ and the acute angle γ is 90 degrees. In one embodiment, the lift angle θ of rotation is approximately 45 degrees. Because both folding motions are occurring simultaneously or semi-simultaneously, a coordinated, multi-planar fold motion is accomplished.

In some embodiments, the flow of hydraulic fluid through the various hydraulic circuits are adjusted so that, in folding from the field configuration 32 to the transport configuration 34, the extension stroke of inner wing lift cylinders 162 are completed before the retraction stroke of the mud-wing pivot cylinders 164. In this way, the upward swing of the mid-wing sections 84 is completed before the retraction of the raid-wing pivot cylinders 164, so that the mid-wing sections 84 are positioned above the brackets 68 before the full retraction stroke of the mid-wing pivot cylinders 164 brings them to rest on the brackets 68. In this way, the brackets 68 can be configured to provide reliable registration by gravity alone, without need for affirmative clamping of the foldable wings 80 thereto. Alter natively, or in addition, hydraulic pressure to the mid-wing pivot cylinders 164 may be maintained when in the retracted configuration. The hydraulic system may also be configured so that, when unfolding from the transport configuration 34 to the field configuration 32, the hydraulic fluid flows first to the extending mid-wing pivot cylinders 164, before flow to the retracting inner wing lift c finders 162 is initiated. In this way, the mid-wing sections 84 lift away from the brackets 68 before the inner wing sections 84 are swung downward, thus preventing hang up of the foldable wings 80 on the brackets 68.

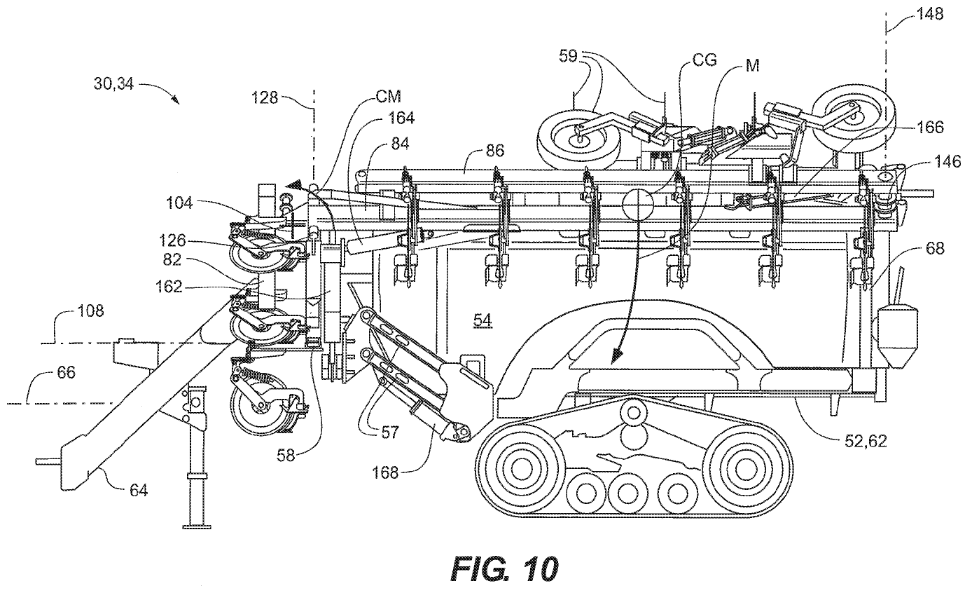

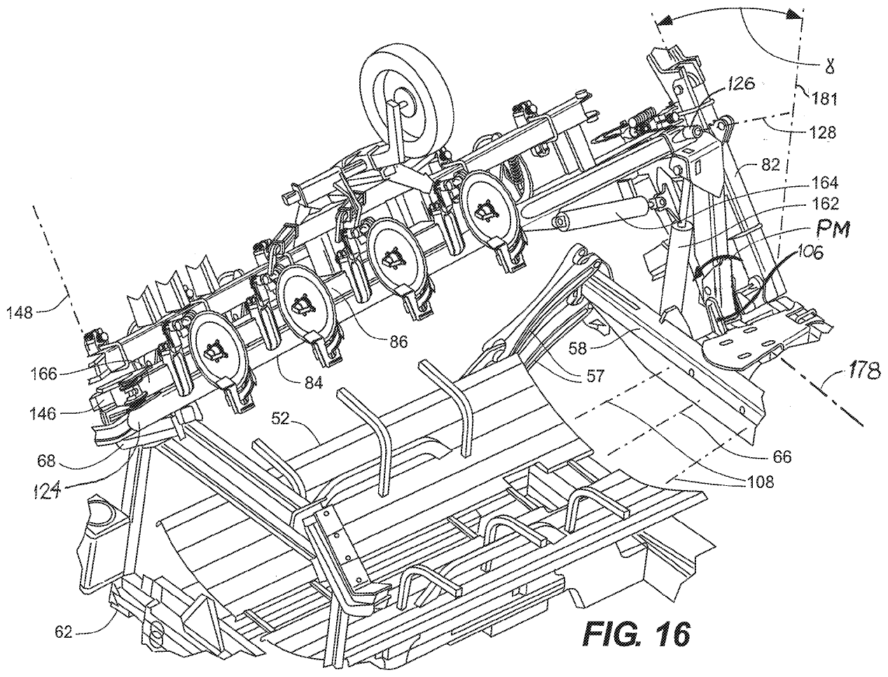

When the mid-wing section 84 and the outer wing section 86 are being folded or unfolded, the weight of the wing sections 84 and 86 (represented by a center of gravity CG in FIG. 10) applies a moment M about the inner wing section 82 (clockwise in FIG. 10), thereby applying a pitching moment PM about a lateral axis 178 of the inner hinge assembly 106 (FIG. 16), the lateral axis 178 being perpendicular to the first horizontal pivot axis 108. To counteract the moment M, the inner wing lift cylinder 162 may be disposed rearward of the inner wing section 82, as depicted. The inner wing lift cylinder 162 is also arranged so that, during a lifting action of the inner wing section 82, the inner wing lift cylinder 162 is in compression, i.e., the top end of the inner wing lift cylinder 162 is pushing upward on the inner wing section 82. Because the actuation axis of the inner wing lift cylinder 162 is offset to the rear of the inner wing section 82, the upward force from the inner wing lift cylinder 162 will produce a counteracting moment CM (counterclockwise in FIG. 10) to the moment M imposed on in the inner wing section 82 and the pitching moment PM otherwise countered by the inner hinge assembly 106.

Functionally, locating the first horizontal pivot axis 108 within the maximum horizontal tank width W1 of the holding tank 54 enables the distal end portion 104 of the inner wing section 82 to rotate upward and inward toward a vertical center plane of the agricultural implement assembly 30, so that the inner wing section 82 extends at the ramping angle θ relative to a horizontal datum 180 of the central frame 58 when in the transport configuration 34. In this way, the overall transport width W2 of the agricultural implement assembly 30 does not exceed an allotted dimension when in the transport configuration 34. In the depicted embodiment, the mid-wing section 84 and the outer wing section 86 of the foldable wing assembly 80 extends at least partially over the holding tank 54 when in the transport configuration 34 to stay within the allotted dimension for the overall transport width W2.

In the depicted embodiment, the lift angle ϕ is acute at about 45 degrees and the corresponding ramping angle θ is obtuse at about 135 degrees. In some embodiments, the lift angle n is within a range of 20 degrees to 90 degrees inclusive, and the corresponding ramping angle θ is within a range that is greater than 90 degrees and not greater than 160 degrees. Herein, a range that is said to be “inclusive” indicates that the stated range includes the end point values as well as all values between the end point values. In some embodiments, the lift angle n is within a range of 30 degrees to 75 degrees inclusive, and the corresponding ramping angle θ is within a range of 105 degrees to 1_50 degrees inclusive; in some embodiments, the lift angle ϕ is within a range of 30 degrees to 60 degrees inclusive, and the corresponding ramping angle θ is within a range of 120 degrees to 150 degrees inclusive; in some embodiments, the lift angle ϕ is within a range of 40 degrees to 50 degrees inclusive, and the corresponding ramping angle θ is within a range of 130 degrees to 140 degrees inclusive. In some embodiments, the lift angle is greater than 50 degrees and less than 90 degrees, and the corresponding ramping angle θ is greater than 90 degrees and not greater than 140 degrees; in some embodiments, the lift angle is within a range of 45 degrees to 65 degrees inclusive, and the corresponding ramping angle θ is within a range of 105 degrees to 135 degrees inclusive; in some embodiments, the lift angle ϕ is within a range of 50 degrees to 70 degrees inclusive, and the corresponding ramping angle θ is within a range of 110 degrees to 130 degrees inclusive.

Embodiments are also contemplated where the ramping angle θ is not necessarily obtuse. That is, the ramping angle θ is may be 90 degrees or less, and the lift angle Q may be 90 degrees or more. Such embodiments would still provide the benefit of narrower overall width than conventional rearward-folding toolbars because of the location of the first pivot axis 108 being within the maximum horizontal tank width W1. In such embodiments, the ramping angle θ may be, for example, within a range of 80 degrees to 120 degrees inclusive; in some embodiments, the ramping angle θ is within a range of 80 degrees to 110 degrees inclusive; in some embodiments, the ramping angle θ is within a range of 85 degrees to 95 degrees inclusive.

In the transport configuration 34, the mid-wing sections 84 may rest on the brackets 68. In this way, torsional and other bending stresses otherwise incurred by the first and second hinge assemblies 106 and 126 are reduced in the transport configuration 34. Furthermore, the option of maintaining pressure to the mid-wing pivot cylinders 164 when in the transport configuration 34 actively applies rotational forces about the second hinge assemblies 126, thereby forcing the distal end portions 124 of the mid-wing sections 86 onto the brackets 68 for added securement.

The counteracting moment CM acts to oppose the moment M caused by the weight of the wings, thereby requiring less torsional rigidity of the inner wing section 82. As a result, the inner wing section 82 can be of lighter construction at reduced cost relative to folding toolbars that do not provide a counteracting moment. An additional benefit of reduced torsional load on the inner wing section 82 is the reduced load on the first and second hinge assemblies 106 and 126, providing similar cost benefits in the design.

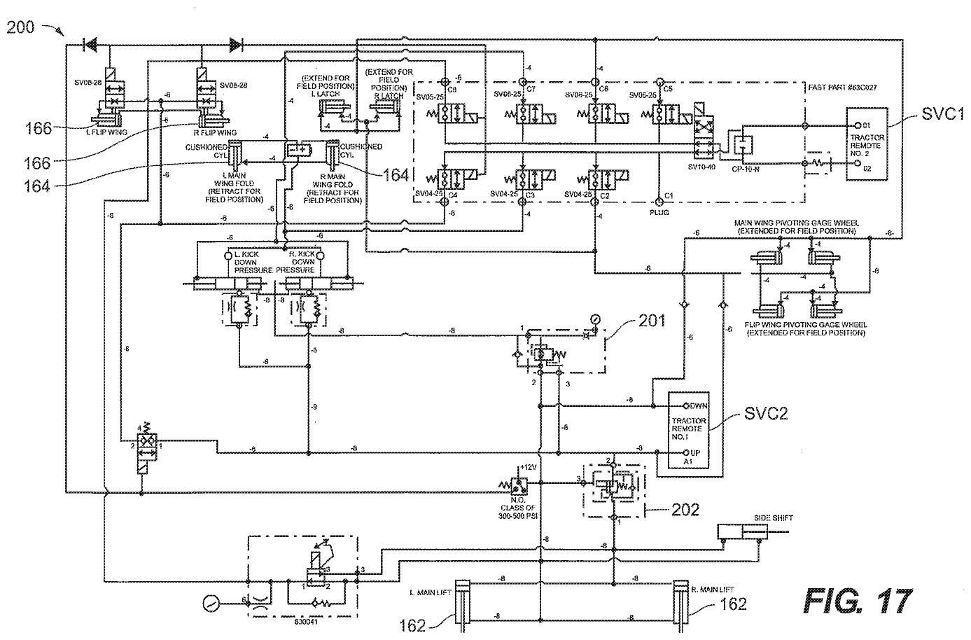

Referring to FIG. 17, a schematic 200 of a hydraulic system for the agricultural implement assembly 30 is depicted in an embodiment of the disclosure. Various hydraulic cylinders identified in FIGS. 1 through 16 are indicated with same-numbered reference characters in the schematic 200. In various embodiments, two hydraulic valve blocks 201 and 202 are disposed on the center frame 58 and inner wing sections 82 (FIG. 5). The valve blocks 201 and 202 are coupled to the various hydraulic cylinders 162, 164, 166, and 168 by hydraulic hoses. In some embodiments, the hydraulic valve blocks 201 and 202 are coupled to selective control valves (SVC) of the towing tractor by hydraulic hoses. The tractor may provide the hydraulic fluid flow and pressure to the hydraulic valve blocks and a path to return hydraulic flow to the tractor. The hydraulic valve block 201 is coupled to a first tractor SCV1, and is used in conjunction with the first tractor SCV1 to raise and lower the tool bar assembly 56 into the raised position 32a and the ground engagement position 32b, respectively, when the tool bar assembly 56 is in the field configuration 32. Hydraulic valve block 202 is coupled to a second tractor SCV2. Hydraulic valve block 202 is used in conjunction with the second tractor SCV2 and a switch box to facilitate folding of the tool bar assembly 56 into the transport configuration 34 and also the unfolding of the tool bar assembly 56 into the extended configuration 32.

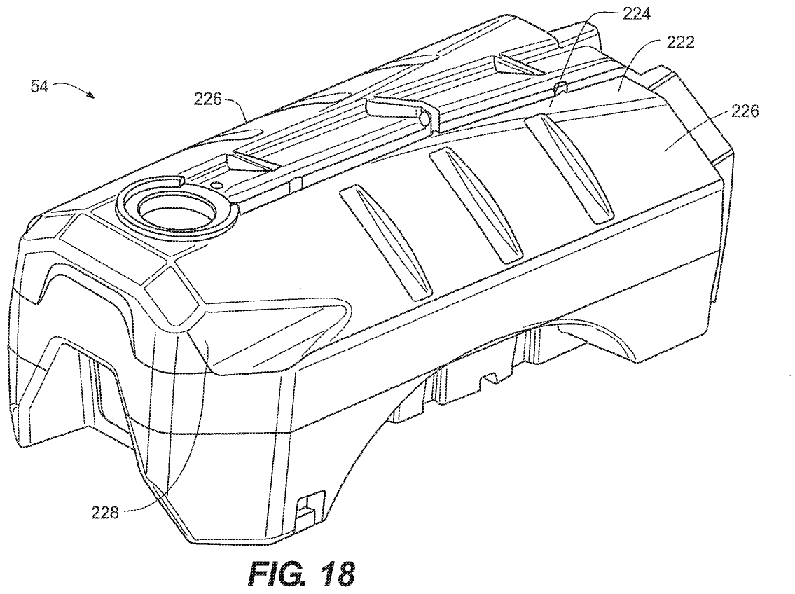

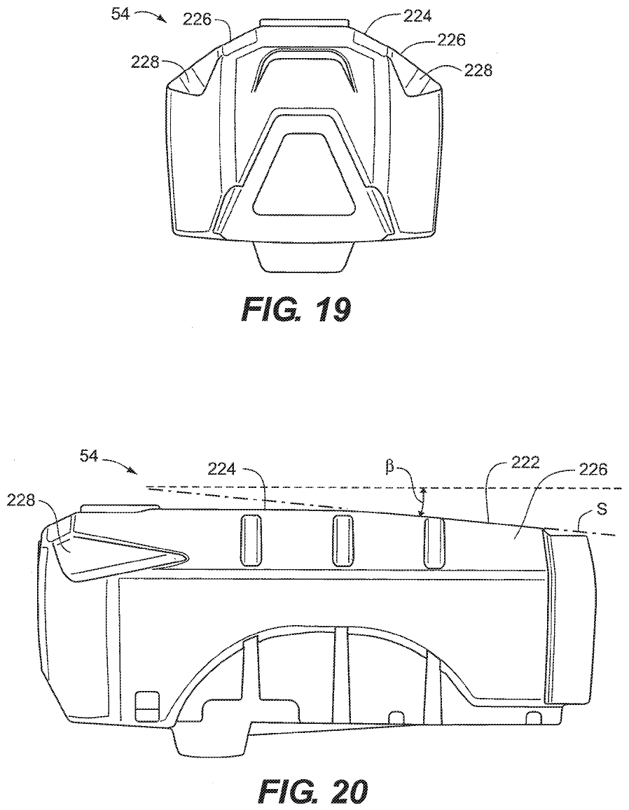

Referring to FIGS. 18 through 20, the holding tank 54 of the agricultural implement assembly 30 is depicted in an embodiment of the disclosure. In the depicted embodiment, at least a rearward portion 222 of a top surface 224 of the holding tank 54 defines a nominal downward slope S. Contoured side portions 226 of the top surface 224 are shaped to slope downward in a lateral outward direction. In some embodiments, the upper forward corners of the holding tank 54 define recesses 228.

Functionally, the nominal downward slope of the rearward sloping portion 222 provides better sight lines for an operator in a cab of a tractor, as outlined below. The contoured side portions 226 enable the foldable wings 80 to swing up and over the holding tank 54 for stowage in the transport configuration 34. The recesses 228 provide clearance for the mid-wing pivot cylinders 164 when the tool bar assembly 56 is in the transport configuration 34, enabling the mid-wing pivot cylinders 164 to act as gussets between the inner wing sections 82 and the mid-wing sections 84 for structural support in the transport configuration 34.

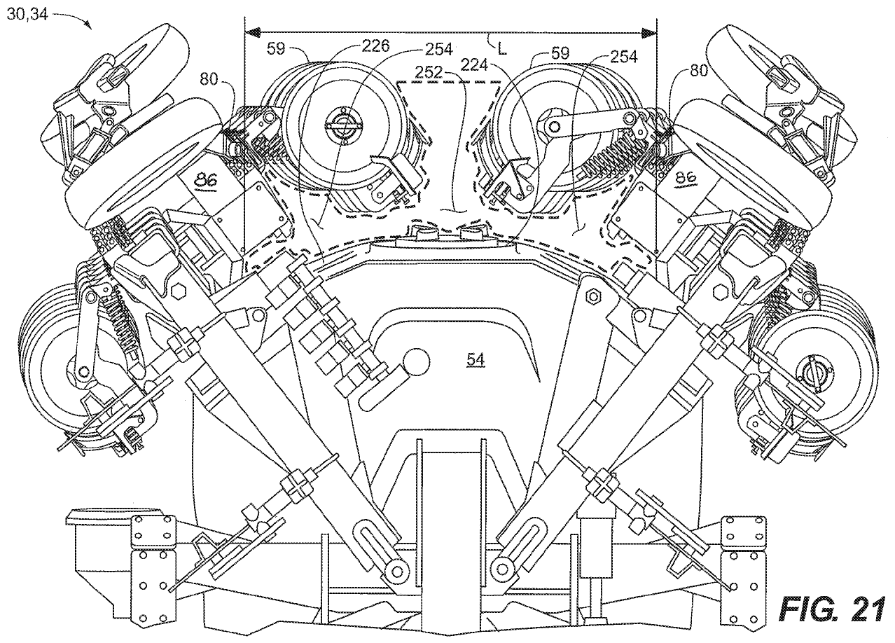

Referring to FIG. 21, a central viewing opening 252 and a pair of lateral viewing openings 254 are depicted in an embodiment of the disclosure. In FIG. 21, the viewing openings 252 and 254 are presented as seen from the vantage point of an operator in a towing vehicle that is towing the agricultural implement assembly 30 in the transport configuration 34. The viewing openings 252 and 254 are framed by the rearward sloping portion 222 of the upper surface 224 of the holding tank 54, the contoured side portions 226, and the presence of the outer wings 86 of the foldable wings 80 over the top surface 224 of the holding tank 54. The combined area of the viewing openings 252 and 254 represents an area of continuous, uninterrupted viewing across a lateral dimension L, the continuous area being outlined by a thick dashed line in FIG. 21. The lateral dimension L defines a lateral viewing angle α (overlaid on FIG. 9), the lateral viewing angle being defined from a hitch point 256 at the proximal end of the hitch 64.

To obtain the depicted configuration of FIG. 21, the upward rotational travel of the inner wing sections 82 is limited to maintain the visibly-open viewing openings 252, 254 between the outer wings 86 of the foldable wings 80 and over the top surface 224 of the holding tank 54. Accordingly, even though the mid-wings 84 and the outer wings 86 extend substantially in a fore-and-aft direction (i.e., substantially parallel to the x-axis of the Cartesian coordinate 100 of FIG. 1) and present a blockage of portions of the rearward view of a roadway behind the agricultural implement assembly 30, the operator can still see a wide portion of the roadway by virtue of the profile of the holding tank 54 (i.e., the rearward sloping portion 222 of the upper surface 224 and the contoured side portions 226) and the arrangement and location of the foldable wings 80 in the transport configuration 34.

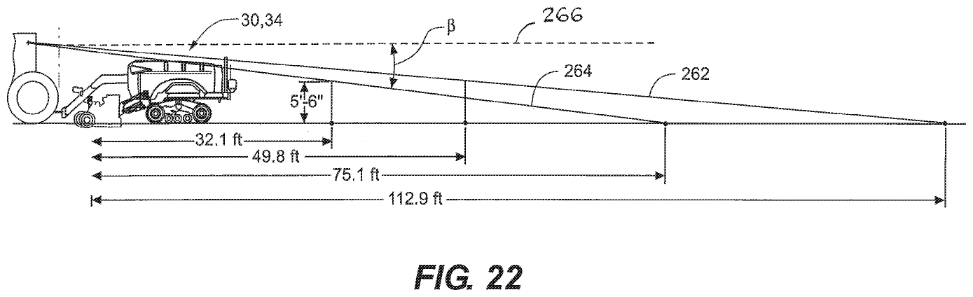

Referring to FIG. 22, the utility of the viewing openings 252, 254 is depicted. A first line-of-sight 262 is defined by viewing opening 252 and a second line-of-sight 264 defined by viewing openings 254. In the depicted embodiment, the second line-of-sight 254 is lowermost and is tangential to the rearward sloping portion 222 and is what defines the nominal downward slope S of the rearward sloping portion 222. That is, the nominal downward slope is defined by a viewing angle β that is relative to horizontal, and originates at a point represented by the vantage point of the operator. The distance of the first and second line-of-sights 262 and 264 to the ground level ranges from approximately 76 feet to approximately 113 feet. The distance of the first and second line-of-sights 262 and 264 to an object that is 51/2 feet from the ground (typical, for example, of the height of automobile roof tops) ranges from approximately 32 feet to approximately 50 feet. A third line-of-sight 266 is also depicted, representing what the line of sight would be if the foldable wing assemblies 80 were drawn in so far as to block the viewing openings 252 and 254. The line-of-sight 266 is effectively parallel to the ground, indicating that the view of the road would effectively be blocked. Also, in the depicted embodiment, the lateral angle α enables viewing of the full 11-foot width of a standard roadway lane at these distances.

In various embodiments of the disclosure, the minimum vertical clearance between ground engagement tools 59 of the foldable wings 80 is in a range of 2 inches to 12 inches inclusive. In the depicted embodiment, the lateral angle α is approximately 15 degrees. In some embodiments, the lateral angle α is within a range of 5 degrees to 25 degrees inclusive; in some embodiments, the lateral angle α is within a range of 5 degrees to 20 degrees inclusive; in some embodiments, the lateral angle α is within a range of 10 degrees to 15 degrees inclusive. In the depicted embodiment, the viewing angle is about 7 degrees. In some embodiments, the viewing angle β is within a range of 4 degrees to 10 degrees.

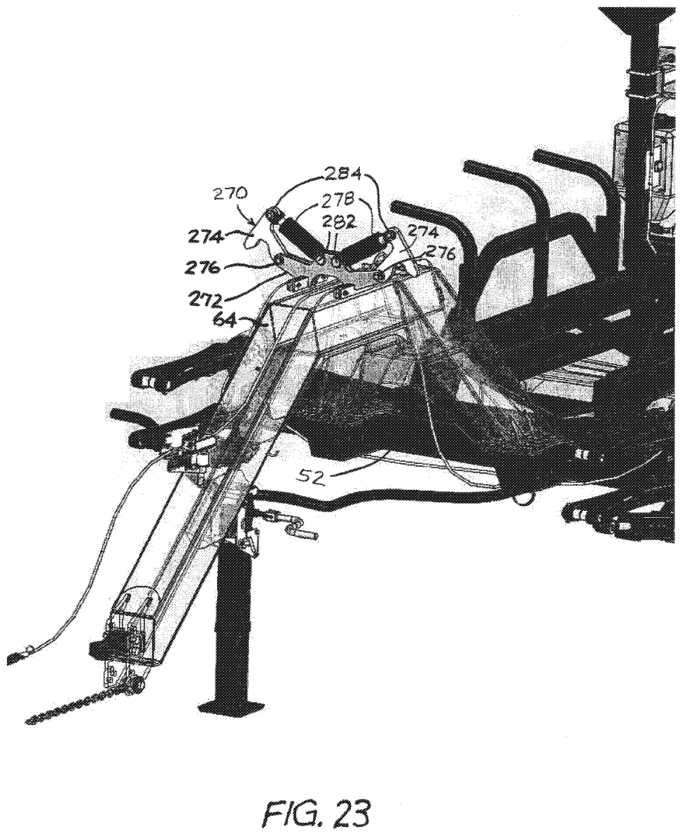

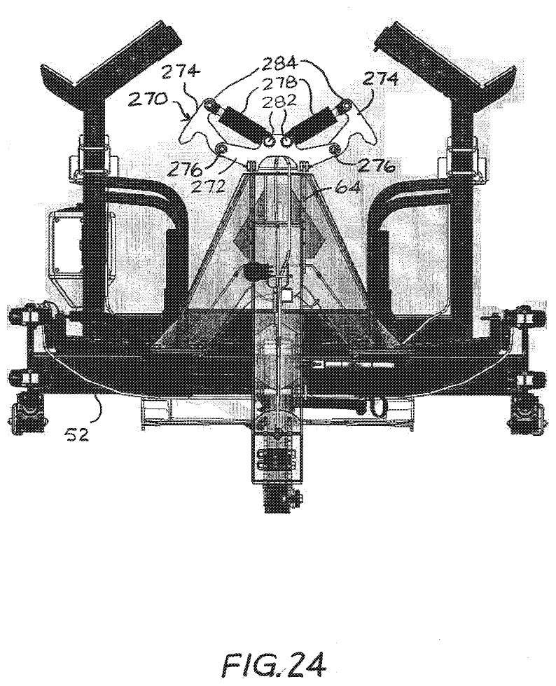

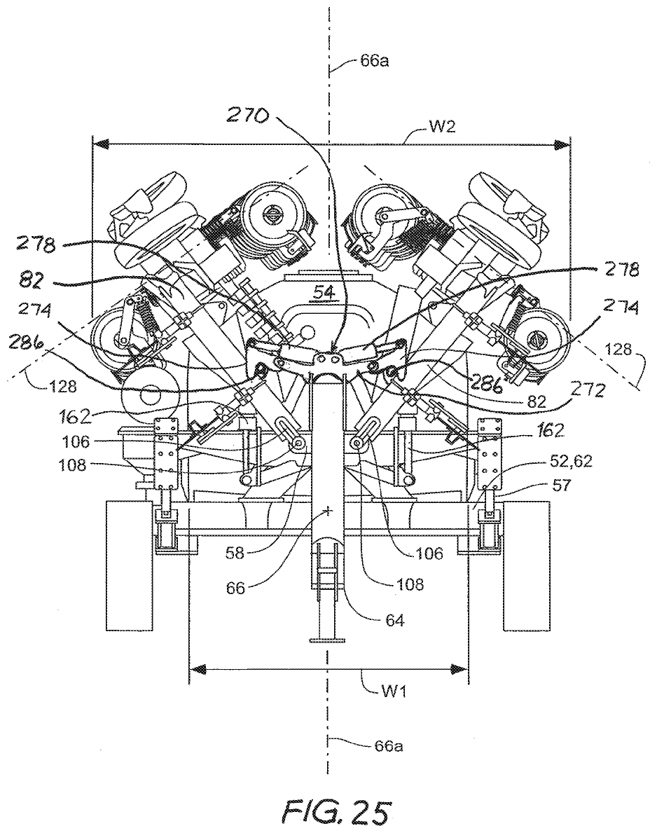

Referring to FIGS. 23 through 25, an inner wing latch assembly 270 is depicted according to an embodiment of the disclosure. The inner wing latch assembly 270 includes a base 272 to which latch hooks 274 are mounted at pivots 276. In the depicted embodiment, the inner wing latch assembly 270 includes latch actuators 278 that bridge the pivot pins 276. The latch actuators 278 are coupled to the base 272 at pivots 282, and are also coupled to the latch hooks 274 at pivots 284. The inner wing latch assembly 270 may be selectively latched to latch pins 286 that are coupled to the inner wing sections 82 (FIG. 25). The actuators may be hydraulic cylinders (depicted), pneumatic cylinders, or electrical actuators.

In operation, the when the agricultural implement assembly 30 is in the transport configuration 34 with the inner wing sections 82 at the fixed lift angle θ, the latch pins 286 are in a position to be latched with the latch hooks 274 of the inner wing latch assembly 270. To deploy the inner wing latch assembly 270, the actuators 278 are actuated, causing the latch hooks 274 to engage the latch pins 286.

Functionally, engagement of the latch hooks 274 with the latch pins 286 secures the inner wing sections 82 at substantially the fixed lift angle θ. This reduces stresses on the folded wing assemblies 80 during transport, and also enables the folded wing assemblies 80 to be secured in the transport configuration 34 without need for the inner wing lift cylinders 162 to remain actively, actuated. For example, for embodiments utilizing hydraulic cylinders for the inner wing lift cylinders 162, deployment of the inner wing latch assembly 270 as described above enables hydraulic pressure to be removed while securing the agricultural implement assembly 30 in the transport configuration 34. The ability to de-energize the actuators of the system while maintaining the transport configuration 34 has particular utility when stowing the agricultural implement assembly 30 for long periods of non-use.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Unless indicated otherwise, references to “embodiment(s)”, “disclosure”, “present disclosure”, “embodiment(s) of the disclosure”, “disclosed embodiment(s)”, and the like contained herein refer o the specification (text, including the claims, and figures) of this patent application that are prior art.

For purposes of interpreting the claims, it is expressly intended that he provisions of 35 U.S.C. 112(f) are not to be invoked unless the specific terms “means for” or “step for” are recited in the respective claim.

1. A liquid fertilizer applicator, comprising:
a carriage defining a towing axis;
a holding tank mounted to said carriage, said holding tank having a maximum horizontal width in a direction that is perpendicular to said towing axis;
a central frame coupled to a first end portion of said carriage and centered about said towing axis; and
a foldable tool bar including a first wing section having a proximal end portion coupled to said central frame with a first hinge assembly, said first hinge assembly defining a first horizontal pivot axis that is substantially parallel to said towing axis,
wherein said first horizontal pivot axis is within said maximum horizontal width of said holding tank.

2. The liquid fertilizer applicator of claim 1, wherein said first wing section extends at an obtuse ramping angle relative to said central frame when the liquid fertilizer applicator is in a transport configuration.

3. The liquid fertilizer applicator of claim 2, wherein said obtuse ramping angle is in a range of 120 degrees to 150 degrees inclusive.

4. The liquid fertilizer applicator of claim 1, comprising an inner wing lift hydraulic cylinder that bridges said first horizontal pivot axis, a first end of said inner wing lift hydraulic cylinder being coupled to said central frame and a second end of said inner wing lift hydraulic cylinder being coupled to said first wing section.

5. The liquid fertilizer applicator of claim 4, wherein said inner wing lift hydraulic cylinder is extended to configure said first wing section at an obtuse ramping angle relative to said central frame, and said inner wing lift hydraulic cylinder is retracted to configure said first wing section in a substantially horizontal orientation.

6. The liquid fertilizer applicator of claim 1, wherein said foldable tool bar includes a second wing section having a proximal end portion coupled to a distal end portion of said first wing section with a second hinge assembly, the second hinge assembly defining a second pivot axis that extends in a direction perpendicular to said first horizontal pivot axis.

7. The liquid fertilizer applicator of claim 6, wherein said second wing section extends above a portion of said holding tank when the liquid fertilizer applicator is in a transport configuration.

8. The liquid fertilizer applicator of claim 7, wherein said second wing section extends substantially parallel to said towing axis when the liquid fertilizer applicator is in said transport configuration.

9. The liquid fertilizer applicator of claim 6, wherein said foldable tool bar includes a third wing section having a proximal end portion coupled to a distal end portion of said second wing section with a third hinge assembly, the third hinge assembly defining a third pivot axis that extends in a direction perpendicular to said second pivot axis, wherein said third pivot axis is substantially parallel to said first pivot axis when the liquid fertilizer applicator is in an extended configuration.

10. The liquid fertilizer applicator of claim 9, wherein said third wing section is folded substantially adjacent said second wing section when the liquid fertilizer applicator is in a transport configuration, said third wing section extending above a portion of said holding tank when the liquid fertilizer applicator is in said transport configuration.

11. The liquid fertilizer applicator of claim 6, comprising a bracket coupled to a second end portion of said carriage, said bracket extending above at least a portion of said holding tank, said second wing section resting on said bracket when the liquid fertilizer applicator is in a transport configuration.

12. The liquid fertilizer applicator of claim 11, comprising an inner wing latch assembly configured to selectively secure said first wing section at an obtuse ramping angle relative to said central frame when in said transport configuration.

13. The liquid fertilizer applicator of claim 9, comprising:
an inner wing lift hydraulic cylinder that bridges said first horizontal pivot axis, a first end of said inner wing lift hydraulic cylinder being coupled to said central frame and a second end of said inner wing lift hydraulic cylinder being coupled to said first wing section;
a mid-wing pivot hydraulic cylinder that bridges said second pivot axis, a first end of said mid-wing pivot hydraulic cylinder being coupled to said first wing section and a second end of said mid-wing pivot hydraulic cylinder being coupled to said second wing section; and
an outer wing hydraulic cylinder that bridges said third pivot axis, a first end of said outer wing hydraulic cylinder being coupled to said second wing section and a second end of said outer wing hydraulic cylinder being coupled to said third wing section.

14. The liquid fertilizer applicator of claim 13, wherein said inner wing lift hydraulic cylinder extends at an acute angle that is less than 45 degrees from horizontal when the liquid fertilizer applicator is in an extended configuration.

15. (canceled)

16. The liquid fertilizer applicator of claim 13, wherein said inner wing lift hydraulic cylinder, said central frame, and said first wing section are configured to counter a pitching moment about said first hinge assembly when the liquid fertilizer applicator is in a transport configuration.

17.-19. (canceled)

20. The liquid fertilizer applicator of claim 13, comprising a hydraulic system configured to simultaneously actuate said inner wing lift hydraulic cylinder and said mid-wing pivot hydraulic cylinder for retraction of said foldable tool bar from a field configuration to a transport configuration, said hydraulic system being configured so that said inner wing lift hydraulic cylinder rotates said first wing section to a fixed lift angle cefore said mid-wing pivot hydraulic cylinder fully rotates said second wing section into the transport configuration.

21.-23. (canceled)

24. The liquid fertilizer applicator of claim 20, wherein said hydraulic system is configured to fold said third wing section into the transport configuration before actuating said inner wing lift hydraulic cylinder and said mid-wing pivot hydraulic cylinder.

25. The liquid fertilizer applicator of claim 13, comprising a hydraulic system configured to simultaneously actuate said inner wing lift hydraulic cylinder and said mid-wing pivot hydraulic cylinder for retraction of said foldable tool bar from a transport configuration to a field configuration, said hydraulic system being configured so that said mid-wing pivot hydraulic cylinder partially rotates said second wing section toward the field configuration before said inner wing lift hydraulic cylinder rotates said first wing section toward the field configuration.

26.-27. (canceled)

28. The liquid fertilizer applicator of claim 25, wherein said hydraulic system is configured for actuation of said outer wing hydraulic cylinder to unfold said third wing section into the field configuration.

29. The liquid fertilizer applicator of claim 28, wherein said hydraulic system is configured to unfold said third wing section into the field configuration after actuating said inner wing lift hydraulic cylinder and said mid-wing pivot hydraulic cylinder into the field configuration.

30.-39. (canceled)
